(19) United States
(12) Patent Application Publication
(10) Pub. No.: US 2005/0257836 A1
(43) Pub. Date: Nov. 24, 2005

(54) Gas pressure regulator

(76) Inventors: Robert Boyer, Flower Mound, TX (US); Tommy Madewell, Argyle, TX (US)

Correspondence Address: HARNESS, DICKEY, & PIERCE, P.L.C, 7700 BONHOMME, STE 400, ST. LOUIS, MO, 63105, US

(21) Appl. No.: 10/848,625

(22) Filed: May 18, 2004

(51) Int. Cl. G05D 16/04

(52) U.S. Cl. 137/505.34

(57) ABSTRACT

A gas pressure regulator capable of minimizing vibration and improving overall fluid flow efficiency. The gas pressure regulator achieves these benefits using varying techniques including providing a nozzle having a primary passage, a secondary passage, and a flow channel groove to smooth the fluid flow, reduce turbulence, and improve overall flowrate, without adversely effecting the necessary backpressure required for reliable operation. Additionally, the gas pressure regulator may use angled walls in the low-pressure cavity to enhance deflection and distribution. Still further, the gas pressure regulator may use additional flow channels to permit smooth fluid flow while eliminating fluid impact.

### FIELD OF THE INVENTION

The present invention generally relates to gas pressure regulators and, more particularly, relates to a gas pressure regulator capable of decreasing internal vibration and increasing flow efficiency therethrough to provide improved flow performance.

### BACKGROUND OF THE INVENTION

In many situations, gas pressure regulators are used to control and/or maintain a desired fluid flow and pressure for use in operating a wide variety of machines, devices, and the like. In this regard, it is desirable for gas pressure regulators to provide a stable and consistent fluid flow rate and/or fluid pressure so as not to hinder the operation of or damage downstream machines or devices. Unfortunately, many conventional gas pressure regulators suffer from various disadvantages that may lead to encumbered operation, such as internal vibration or decrease flow efficiency.

Conventional gas pressure regulators generally include a valve assembly that is selectively and automatically actuated to maintain a desired set pressure in response to a downstream pressure. This is typically achieved using an adjusting spring that applies a pressure to a spool member of a valve assembly. The adjusting spring is set by an operator via an adjusting knob to a predetermined biasing force. Once an internal fluid pressure, acting on a diaphragm member, overcomes this predetermined biasing force, the valve assembly is closed. As fluid is consumed by the work device, the pressure within the low-pressure cavity drops, which starts the cycle to continue again—the diaphragm moving up and down, opening and closing the seat, to maintain a constant pressure within the regulator based on the load applied by turning the adjusting knob.

However, conventional gas pressure regulators suffer from a number of disadvantages. For example, as flow rate needs increase, the valve assembly, namely the valve seat, will open further in reaction to the diaphragm dropping more and more as it attempts to compensate for increased pressure loss: in the low-pressure cavity. When this happens, the adjusting spring correspondingly decompresses, since its length is now increasing as the diaphragm lowers with respect to a stationary adjusting knob position. As its length increases, the force it applies to the top of the diaphragm decreases, at a rate determined by the spring rate of the adjusting spring. This force balances the forces in the regulator to achieve a desired delivery pressure and, consequently, causes the delivery pressure out of the regulator to drop as flow rate increases. This effect is illustrated in FIG. 7. With reference to FIG. 7, it can be seen that with an initial pressure setting of the regulator of 125 PSIG, at maximum flow rate, (i.e. 2500 SCFH), the outlet pressure decreases about 100 PSIG. This is the nature of most conventional gas pressure regulators. It is generally understood in the art that a “flatter” or level curve is most desirable as it indicates a more uniform delivery pressure between zero flow and max flow. Therefore, since the pressure rapidly exiting the gas regulator is causing the diaphragm to drop (which causes delivery pressure to drop), then the faster the valve assembly can take the inlet pressure and fill the low-pressure cavity, the faster the regulator can keep up with the flow demands and therefore, the less the diaphragm will drop to compensate. If the diaphragm does not need to drop as much to compensate, then this means that the adjusting spring is unloading less, and therefore the delivery pressure is staying more constant.

However, while speeding things up inside the regulator can make it perform better, it can also increase turbulence and vibration—two of the biggest problems in pressure regulation.

Turbulence is often caused when the increased flow rate demands turn the velocity of the flow inside the regulator supersonic in various key areas—at the valve seat itself, where the high inlet pressure drops rapidly; through the nozzle (including the nozzle outlet holes); and through the outlet holes of the low-pressure cavity. With this increase in velocity also comes an increase in turbulence—not only at the nozzle/seat area, but also inside the low-pressure cavity, as the high velocity stream coming out of the nozzle hole is diffused into the larger cavity area. This turbulence, regardless of its origin, can have negative impacts on the regulator performance—it can not only decrease efficiency of the regulator, slowing the gas flow down, but more importantly, it can also cause vibration inside the regulator.

Vibration can also lead to disadvantageous operation of gas pressure regulators. When the regulator is in a flowing state, the contact point between the stem of the valve assembly and the diaphragm is “floating” on two springs—the adjusting spring controlling the position of the diaphragm, and the valve spring controlling the position of the spool member and stem. Vibration from the seat area (the contact between the spool member and the sealing surface) or vibration applied against the bottom side of the diaphragm will translate directly into this floating contact point. Additionally, the nature of springs serves to amplify the effects of vibration—especially if the frequency of the vibration is near (or the same as) the natural harmonic frequency of either spring. Friction dampening devices have been used in an attempt to overcome the vibration, but their use dampens the reaction performance and flexibility of the diaphragm leading to sluggish performance and decreased consistency.

Vibration can get unmanageable if the diaphragm and the stem vibrate at such a rate that they can no longer vibrate together, at the same frequency, and therefore lose contact with each other and vibrate independently. The term “singing” is widely used in the industry to describe when this happens. When the diaphragm and stem lose contact with each other and vibrate independently, they will slam into each other at the rate of their vibration and create a violent high frequency buzzing sound. When a regulator sings, the action is usually violent enough to cause internal damage to the regulator. Most notably, the seat itself will be damaged from the repeated high frequency impact and may cause the regulator to leak. This vibration can also travel along the fluid downstream to a work device.

### SUMMARY OF THE INVENTION

According to the principles of the present invention, a gas pressure regulator having an advantageous construction and a method of using the same is provided, which may find utility in a wide variety of applications. The gas pressure regulator of the present invention is capable of minimizing vibration and improving overall fluid flow efficiency. The gas pressure regulator achieves these benefits by varying techniques including providing a nozzle having a primary passage, a secondary passage, and a flow control groove to smooth the fluid flow, reduce turbulence, and improve overall flowrate, without adversely affecting the necessary backpressure required for reliable operation. Additionally, the gas pressure regulator may use angled walls in the low-pressure cavity to enhance deflection and distribution. Still further, the gas pressure regulator may use additional flow channels to permit smooth fluid flow while eliminating fluid impact.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view illustrating a gas pressure regulator incorporating the principles of the present invention;

FIG. 2 is a cross-sectional view illustrating the gas pressure regulator according to the present invention;

FIG. 3 is an enlarged perspective view illustrating a nozzle of the present invention with portions shown hidden;

FIG. 4(a) is a cross-sectional view illustrating the gas pressure regulator having a primary passageway according to the present invention;

FIG. 4(b) is a cross-sectional view illustrating the gas pressure regulator having a primary passageway and a secondary passageway according to the present invention;

FIG. 4(c) is a cross-sectional view illustrating the gas pressure regulator having a primary passage, secondary passage, and flow channel groove according to the present invention;

FIG. 5 is an enlarged cross-sectional view illustrating a portion of the gas pressure regulator;

FIG. 6(a) is an enlarged perspective view illustrating a base portion of the regulator body having one discharge channel with portions shown hidden;

FIG. 6(b) is an enlarged perspective view illustrating a base portion of the regulator body having a pair of discharge channels with portions shown hidden;

FIG. 7 is a graph illustrating delivery pressure of a conventional gas pressure regulator;

FIG. 8 is a cross-sectional view illustrating an alternative embodiment of the gas pressure regulator having a primary passage and secondary passage disposed parallel to a longitudinal axis of the nozzle; and

FIG. 9 is a cross-sectional view illustrating an alternative embodiment of the gas pressure regulator having a primary passage and secondary passage disposed orthogonal to a longitudinal axis of the nozzle.

### DETAILED DESCRIPTION OF THE PREFERRED EMBODIMENT

The following description of the preferred embodiment is merely exemplary in nature and is in no way intended to limit the invention, its application, or uses.

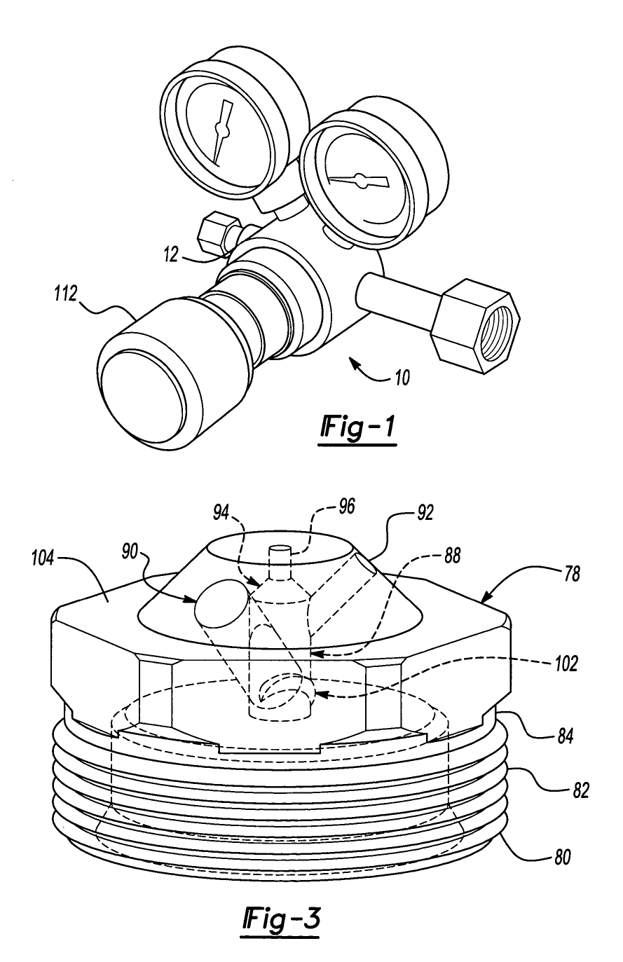

Referring now to the drawings in which like reference numerals designate like or corresponding parts throughout the several views, a gas pressure regulator, generally indicated as 10, is illustrated incorporating the principles of the present invention. As seen in FIG. 1, gas pressure regulator 10 may be used in conjunction with a pair of pressure gauges for displaying an inlet and an outlet pressure.

Referring now to FIG. 2, gas pressure regulator 10 generally includes a regulator body 12. Regulator body 12 includes a base portion 14 and an upper portion 16. Upper portion 16 of regulator body 12 defines a threaded locking flange 18 adapted to threadedly engage corresponding threads 20 formed on base portion 14 of regulator body 12 to permit reliable and simple coupling of base portion 14 and upper portion 16.

Base portion 14 of regulator body 12 defines a longitudinally extending valve bore 22. Similarly, upper portion 16 of regulator body 12 defines a longitudinally extending spring bore 24. Valve bore 22 fluidly communicates with an inlet port 26. Inlet port 26 is adapted to be connected with a source of compressed fluid, such as air. Valve bore 22 further fluidly communicates indirectly with an outlet port 30. The specific configuration and arrangement of such fluid communication between valve bore 22 and outlet port 30 will be described in detail below. Outlet port 30 is adapted to be connected with a load line of a fluid operated device or machine. Base portion 14 of regulator body 12 further includes a plurality of optional mounting apertures 34 adapted to receive fasteners (not shown) therein for mounting.

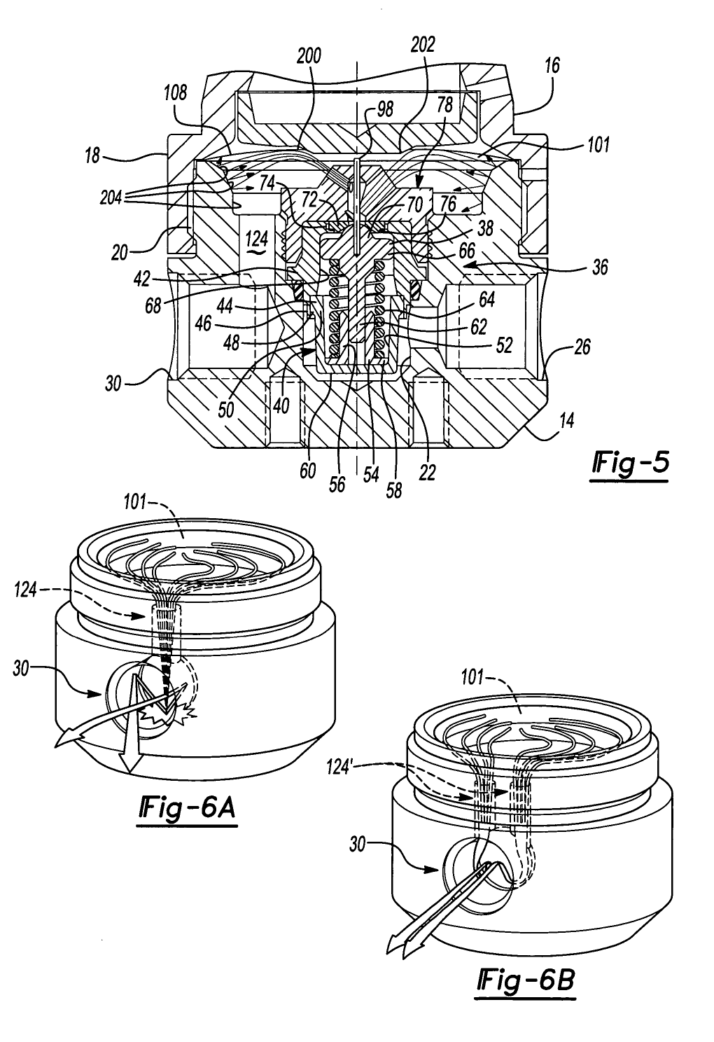

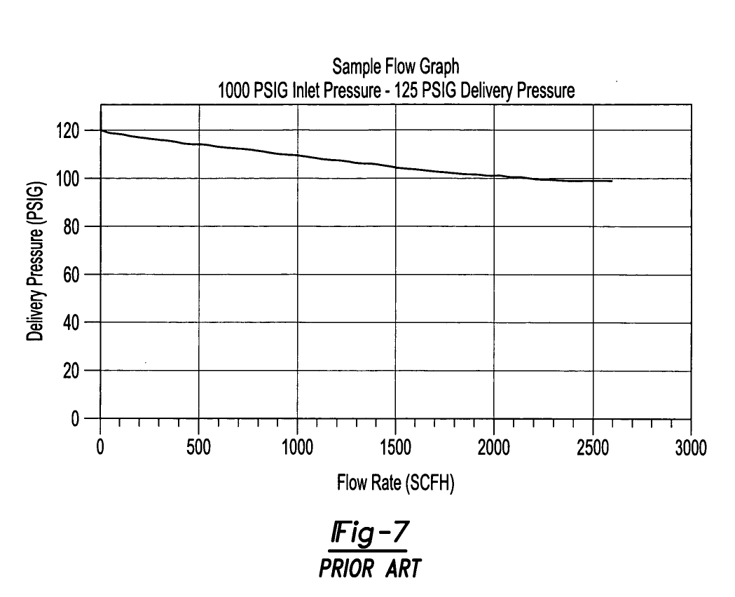

Referring to FIG. 5, valve bore 22 of base portion 14 is generally sized to receive a valve assembly 36. Valve assembly 36 includes a spool member 38 contained within a valve cup 40. Valve cup 40 includes a first half 42 and a second half 44. First half 42 of valve cup 40 includes a flange 46 adapted to engage, such as through crimping, a peripheral edge 50 of second half 44 to prevent relative movement of first half 42 and second half 44. Second half 44 is generally cup shaped having an internal volume 52 sized to receive a spindle member 54 therein. Spindle member 54 includes a cylindrical portion 56 terminating at and integrally formed with a head portion 58. Head portion 58 rests upon an interior base surface 60 of second half 44 of valve cup 40.

Still referring to FIG. 5, cylindrical portion 56 of spindle member 54 is sized to slidably receive a pin 62 of spool member 38. Spool member 38 is biased apart from spindle member 54 via a valve spring 64. At one end, valve spring 64 engages head portion 58 of spindle member 54. At an opposing end, valve spring 64 engages a shoulder portion 66 of spool member 38. Shoulder portion 66 of spool member 38 is slidably received within internal volume 68 of first half 42 of valve cup 40.

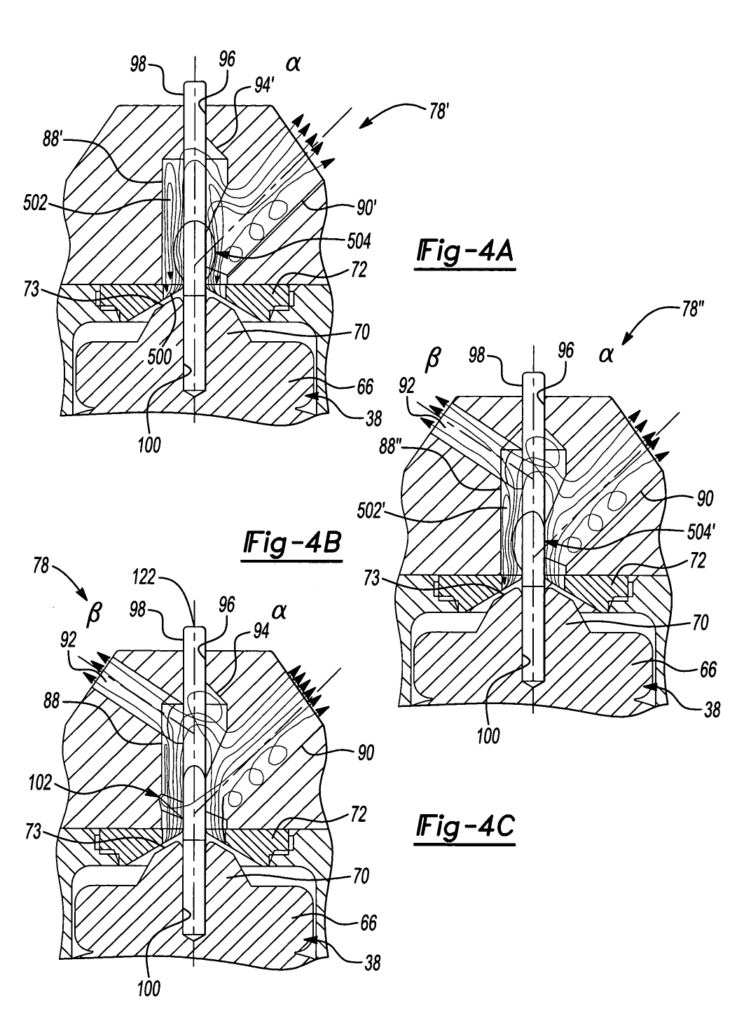

Referring to FIG. 5, spool member 38 further includes a nose portion 70 extending outward from shoulder portion 66. Nose portion 70 is generally coaxial with a longitudinal axis of spool member 38. Nose portion 70 is sized to seat against a seal insert or seat 72 to selectively provide a fluid seal therebetween. That is, when nose portion 70 of spool member 38 is seated against seal insert 72, a fluid seal is defined that prevents fluid from passing through a port 73 (FIG. 4(a)) between inlet port 26 and outlet port 30. When nose portion 70 of spool member 38 is spaced apart from seal insert 72, the fluid seal is broken and fluid passes through port 73 between inlet port 26 and outlet port 30. Seal insert 72 is disposed within a depression 74 formed in first half 42 of valve cup 40. Seal insert 72 is retained within depression 74 between a flange 76 and a nozzle 78, which will be described further below.

As best seen in FIGS. 2, 3, and 5, nozzle 78 includes a flange 80 circumferentially extending about a lower portion of nozzle 78. Flange 80 includes a threaded portion 82 disposed about an exterior surface 84 of flange 80 to threadedly engage a corresponding set of threads 86 extending about valve bore 22 of base portion 14. In this regard, nozzle 78 is threadedly coupled to base portion 14 and further serves to capture seal insert 72 between flange 76 and nozzle 78.

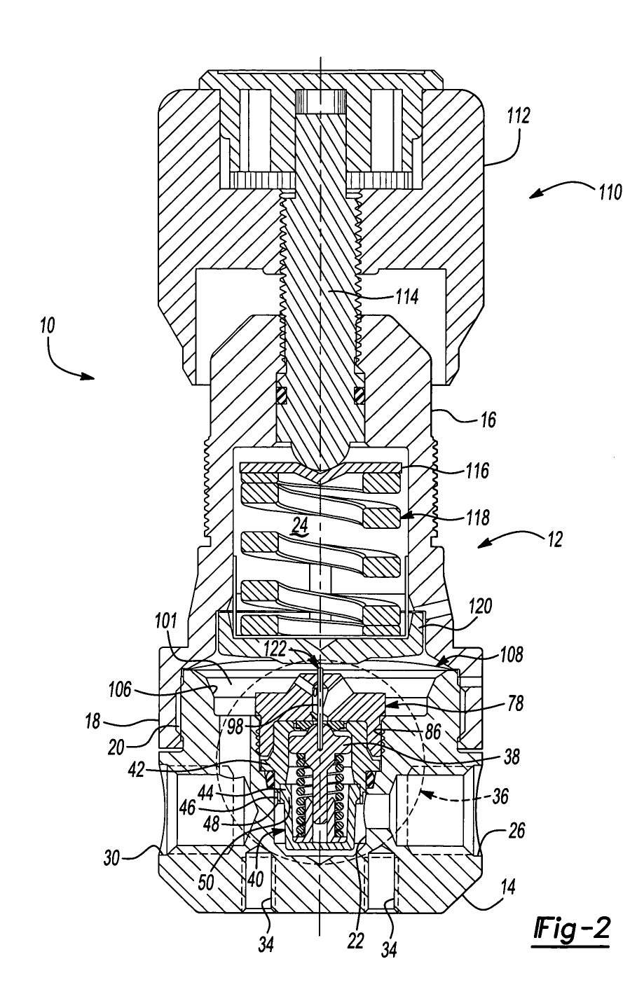

As best seen in FIGS. 3 and 4(a)-(c), nozzle 78 further includes a nozzle cavity 88, a primary passageway 90, and a secondary passageway 92. Nozzle cavity 88 extends between port 73 and primary passageway 90 and secondary passageway 92 to define a fluid path from port 73 to both primary passageway 90 and secondary passageway 92. Nozzle cavity 88 terminates at an inclined ceiling 94. Inclined ceiling 94 includes a bore 96 sized to slidably receive a stem member 98 therethrough. Stem member 98 extends from bore 96 of nozzle 78, through nozzle cavity 88 and is received within a bore 100 formed through nose portion 70 of spool member 38. Stem member 98 serves to first define an engagable connection between spool member 38 and a diaphragm member 108 (described below). Additionally, stem member 98 serves to maintain axial alignment of spool member 38 relative to nozzle 78 and seal insert 72.

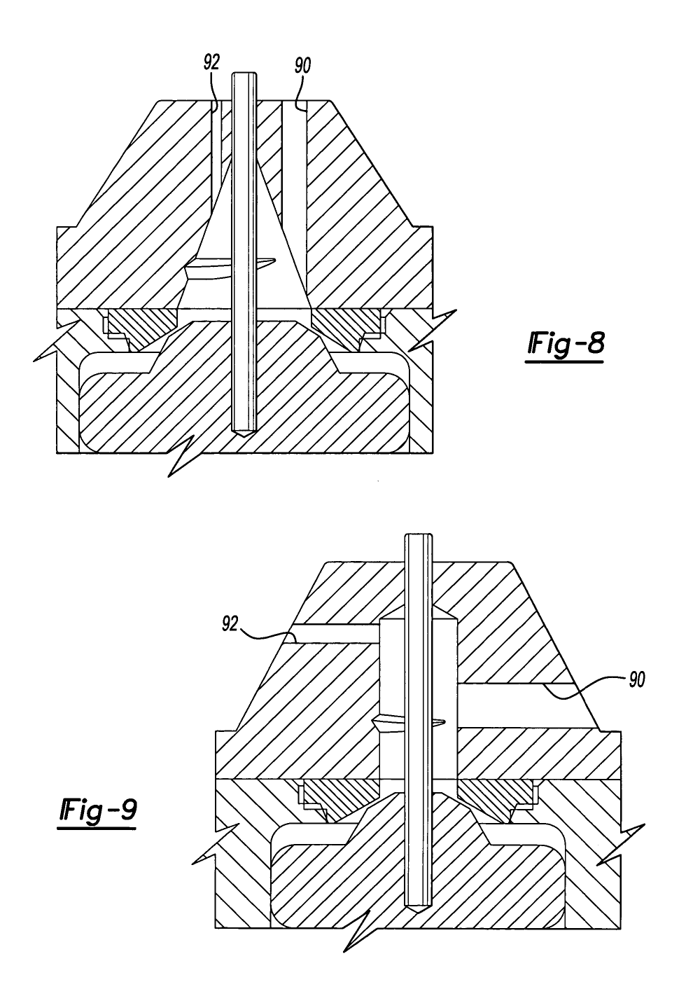

Primary passageway 90 is disposed within nozzle 78 at an angle a inclined relative to a longitudinal axis of nozzle cavity 88. Similarly, secondary passageway 92 is disposed within nozzle 78 at an angle β inclined relative to the longitudinal axis of nozzle cavity 88. Preferably, secondary passageway 92 is disposed within nozzle 78 in a higher position (as seen in the figures) or, in other words, at a position downstream from primary passageway 90. Furthermore, it is preferable that the internal diameter of secondary passageway 92 is smaller than the internal diameter of primary passageway 90. Both primary passageway 90 and secondary passageway 92 define fluid communication paths between nozzle cavity 88 and a low-pressure cavity 101 (FIG. 5). The specifics of low-pressure cavity 101 will be described in detail below. However, it should be understood that primary passageway 90 and secondary passageway 92 may be disposed at any angle relative to the longitudinal axis of nozzle cavity 88. For example, as seen in FIGS. 8 and 9, primary passageway 90 and secondary passageway 92 may be disposed at any orientation ranging from parallel to the longitudinal axis of nozzle cavity 88 (FIG. 8) to orthogonal to the longitudinal axis of nozzle cavity 88 (FIG. 9). Additionally, nozzle cavity 88 may be of any shape conducive to fluid flow (see FIG. 8). Still further, it should be understood that primary passageway 90 and secondary passageway 92 may have any cross sectional profile, including rectangular, oval, triangular, etc.

Still further, it is preferable that nozzle cavity 88 includes a flow channel groove 102 from therein. As best seen in FIGS. 3 and 4(c), flow channel groove 102 is provided such that it defines a recess or notch formed along a sidewall of nozzle cavity 88. It has been found that flow channel groove 102 serves to minimize the presence of turbulent swirls in the fluid flow traveling through nozzle cavity 88. Flow channel groove 102 can be easily formed by drilling primary passageway 90 deep enough to engage the opposing wall of nozzle cavity 88. In this regard, a groove is formed to provide the enhanced flow control.

Turning now to FIGS. 4(a)-(c), a comparison of flow patterns is illustrated. However, it is believed that a brief background on the use of backpressure in regulators is useful.

In regulators, backpressure is an important characteristic in the overall design. The existence of backpressure serves to help prevent “fluttering.” However, too much backpressure chokes the through flow performance. Without backpressure, the velocity of gas exiting is so fast and the pressure drop so great that the seat simply cannot keep up. This causes the pressure in the low-pressure cavity 101 (to be described below) to drop too fast, and therefore will cause the seat to overcompensate and open too far. Then, since it is open too far, it will cause too much pressure to get past the seat, thereby pushing diaphragm member 108 (FIG. 2) up causing the seat to close quickly. This cycling motion can happen very fast, causing vibration in irregular spasms, or flutter. Therefore, the addition of backpressure creates an intermediate pressure inside the nozzle cavity. This intermediate pressure acts as a buffer zone to help smooth out the movements of the seat as it regulates pressure. Backpressure is thus desirable to an extent and is often created by causing or using a restriction in the fluid flow path. This is physically the only way to increase pressure to create this buffer zone. This restriction, however, will tend to negatively affect the flow by causing turbulent swirls. These turbulent swirls can spiral down the length of the nozzle cavity and impact the top of the high velocity flow stream coming across the seat. If this happens, the frequency of the turbulent swirls will cause vibration within the valve assembly itself, which will carry throughout the rest of the regulator and, if severe enough, could result in “singing.” In addition, because this vibration is not being caused by the springs themselves, friction-dampening devices may not be able to prevent or even dampen it.

The present invention, thus, serves to straighten the fluid flow inside nozzle cavity 88, thereby allowing a backpressure to be maintained, but minimizing the harmful vibration effects of turbulent swirls. The present invention does this using primary passageway 90, secondary passageway 92, and flow channel groove 102. Primary passageway 90, being larger, is the primary flow path for the fluid. The secondary passageway 92, being much smaller and located above primary passageway 90, allows backpressure to build up inside nozzle cavity 88, while at the same time venting this backpressure to low-pressure cavity 101 thereby giving the turbulent swirls an outlet. This prevents the turbulent swirls from swirling back down onto the top of the high velocity stream coming off the seat (see FIG. 4). This is more readily seen in FIGS. 4(a)-(c).

With initial reference to FIG. 4(a), a nozzle 78′ having only a primary passageway 90′ is illustrated. As can been seen, a high velocity fluid stream 500 pasts between nose portion 70 of spool member 38 and seal insert 72 and travels up a nozzle cavity 88′. This high velocity fluid stream 500 impacts inclined ceiling 94′ and is deflected back down in a turbulent flow 502. This turbulent flow 502 swirls and impacts the high velocity fluid stream 500, leading to further turbulent flow and the formation of a bulging effect, generally referenced at 504. This bulging effect 504 translates to a flow stream vibration in nozzle 78′ that both degrades the performance of nozzle 78′, but also limits the flowrate at outlet port 30.

With reference to FIG. 4(b), a nozzle 78″ having both primary passageway 90 and secondary passageway 92 (but no flow channel groove 102) is illustrated. As can be seen, high velocity fluid stream 500 pasts between nose portion 70 of spool member 38 and seal insert 72 and travels up a nozzle cavity 88″. This high velocity fluid stream 500 impacts inclined ceiling 94′ and is deflected back down in a turbulent flow 502′. The turbulent flow swirls of 502′, similar to the turbulent flow swirls of 502, lead to the formation of a bulging effect, generally referenced as 504″. However, when comparing nozzle 78″ with nozzle 78′, illustrated in FIG. 4(a), it can be seen that bulging effect 504″ of nozzle 78″ is considerably smaller than bulging effect 504′ of nozzle 78′. This is a result of the presence of secondary passageway 92, which serves to relieve some of the turbulent flow or otherwise partially “vent” the flow within nozzle cavity 88″. The reduction of bulging effect 504′ reduces the flow stream vibration seen in nozzle 78′. The smaller diameter of secondary passageway 92, however, continues to maintain the proper backpressure for desired performance.

With reference to FIG. 4(c), a nozzle 78 having primary passageway 90, secondary passageway 92, and flow channel groove 102 is illustrated. As can be seen, high velocity fluid stream 500 pasts between nose portion 70 of spool member 38 and seal insert 72 and travels up nozzle cavity 88. Secondary passageway 92 cannot stop all of the harmful turbulent flow though, since it must be sized smaller than primary passageway 90 in order to create backpressure. Consequently, flow channel groove 102 serves to further reduce any turbulent flow. Any turbulent flow that swirls down towards high velocity stream 500 is further dissipated via flow channel groove 102. Flow channel groove 102, positioned just above high velocity stream 500 coming off port 73, creates a channel of increased area within nozzle cavity 88. When the turbulent flow comes down towards high velocity stream 500, this turbulent flow contacts the increased area of flow channel groove 102 causing the velocity of this turbulent flow to decrease, which leads to increased pressure as described by the Continuity Equation. This “wall” of high velocity stream 500 being positioned adjacent the slower moving, higher pressure downward flow near flow channel groove 102 causes the fluid flow to follow the path of least resistance-namely, along flow channel groove 102. As the flow within flow channel groove 102 continues toward the outer edges of flow channel groove 102 near primary passageway 90, it is then influenced by the large volume fluid flow traveling out primary passageway 90. This arrangement creates a siphoning effect on this turbulent flow, thereby carrying it out primary passageway 90 with the rest of the flow stream. The result is that the harmful downward turbulent flow has now been rerouted and guided out through primary passageway 90, thus eliminating any influence it might have had against high velocity flow stream 500.

In other words, the present invention reduces turbulence within nozzle cavity 88 by straightening high velocity flow stream 500, thereby increasing efficiency, and thereby increasing overall performance. Additionally, this straightening of high velocity flow stream 500 further decreases vibration, thereby leading to improved stability of gas pressure regulator 10 and improved pressure delivery consistency.

Turning now to FIGS. 3 and 5, low-pressure cavity 101 is illustrated, which further reduces vibration and improves regulator efficiency. As can be seen from the illustrations, low-pressure cavity 101 is defined along a lower edge by exterior surface 104 of nozzle 78, an interior bore 106 (FIG. 2) of base portion 14, and a diaphragm member 108. Diaphragm member 108 is received between and held in place by a clamping force of base portion 14 and upper portion 16 of regulator body 12.

Referring to FIG. 2, diaphragm member 108 is preferably a flexible member. Pressure is applied to a top surface of diaphragm member 108 through an adjusting mechanism 110. Specifically, adjusting mechanism includes an adjustment knob assembly 112 threadedly coupled to upper portion 16 of regulator body 12. Adjustment knob assembly 112 is adapted to be twisted by an operator to set a desired outlet pressure of gas pressure regulator 10. As adjustment knob assembly 112 is actuated/twisted, an adjustment knob stem 114 engages a spring plate 116, which applies a force against a spring member 118. Spring member 118, disposed within spring bore 24, consequently applies a countering force against a pressure plate 120, which engages diaphragm member 108. Thus, actuation of adjustment knob assembly 112 can be used to apply or remove a pressure against diaphragm member 108. Diaphragm member 108 is driven down in response to this pressure and contacts an end 122 (FIG. 4(c)) of stem member 98 extending upward from spool member 38. Further movement of diaphragm member 108 causes stem member 98 to drive spool member 38 downward (in the figures) against the biasing force of valve spring 64 to off-seat nose portion 70 of spool member 38 from seal insert 72, thereby opening port 73 and permitting high velocity fluid stream 500 to pass therethrough and flow into nozzle cavity 88 and into low-pressure cavity 101 as described above. As fluid pressure within low-pressure cavity 101 increases, the opposing force acting upon diaphragm member 108 overcomes the biasing force of spring member 118 and drives diaphragm member 108 away from stem member 98. Consequently, valve spring 64 urges spool member 38 upward and again seats nose portion 70 into sealing engagement with seal insert 72, thereby closing port 73. Fluid within low-pressure cavity 101 may then exit through discharge channels 124 and outlet port 30.

Low-pressure cavity 101 is particularly shaped to decrease vibration and improve efficiency. As with the nozzle backpressure discussion above, a similar principle holds true for diaphragm member 108. A certain amount of backpressure should be maintained under diaphragm member 108. This backpressure is the delivery pressure of gas pressure regulator 10 and is shown on a delivery pressure gauge. The key to achieving the highest performance of gas pressure regulator 10 is to maximize the flowrate of high velocity stream 500. In this regard, the high flowrate is capable of delivering a high throughput in response to increased downstream load (i.e. a machine or work device). The key to delivering this high throughput is to quickly and efficiently slow down high velocity stream 500, diffuse it, and distribute it evenly through low-pressure cavity 101. If high velocity stream 500 is not evenly distributed throughout low-pressure cavity 101, this causes a force imbalance under diaphragm member 108, which may lead to diaphragm flutter. Furthermore, if the fluid streams exiting primary passageway 90 and secondary passageway 92 are excessively turbulent, then this turbulence may also lead to diaphragm flutter.

In order to achieve the best diffusion possible within low-pressure cavity 101, the shape of low-pressure cavity 101 preferably serves to deflect and distribute the entering fluid flow. To this end, low-pressure cavity 101 includes a first deflecting surface 200 being primarily diaphragm member 108 and its contour over a nub portion 202 formed along an underside of pressure plate 120. Flow from primary passageway 90 and secondary passageway 92 contacts first deflecting surface 200 and is deflected outwardly to a plurality of angled surfaces 204, generally arranged in a convex pattern, formed along interior bore 106 of base portion 14. As can be seen by the flow arrows in FIG. 5, the flow is further deflected from the plurality of angled surfaces 204 into a multitude of directions (or in other words, a fan shaped pattern) to slow the flow, deflect it, and diffuse it to achieve a generally uniform distribution. Ideally, primary passageway 90 is positioned at a side opposite of discharge channels 124 to promote further this diffusion; however, this is not required.

As best seen in FIGS. 6(a)-(b), discharge channels 124 are further designed to enhance the smooth fluid flow, improve efficiency, and reduce vibration. Although the present invention may be used with a single discharge channel 124 (see FIG. 6(a)), it is most desirable to have a pair of discharge channels 124′ disposed generally tangent to outlet port 30. The pair of discharge channels 124′ may be of smaller diameter than single discharge channel 124. Typically, a single centered hole creates a high impact flow area coming out of low-pressure cavity 101, as illustrated in FIG. 6(a). This impact causes vibration, which is carried both downstream to the work device and upstream to the regulator. By using the pair of discharge channels 124′, together with their offset and tangential arrangement, this impact is eliminated or, at least, minimized. The flow follows the pair of discharge channels 124′ from low-pressure cavity 101, swirls along the sides of outlet port 30, and blends smoothly, without impact.

The description of the invention is merely exemplary in nature and, thus, variations that do not depart from the gist of the invention are intended to be within the scope of the invention. Such variations are not to be regarded as a departure from the spirit and scope of the invention.

1. A gas pressure regulator comprising:
a regulator body;
a nozzle disposed within the regulator body, the nozzle comprising:
an interior portion and an exterior portion;
a nozzle cavity disposed within the interior portion, the nozzle cavity defining a proximal end and a distal end;
a primary gas passageway extending between the proximal end of the nozzle cavity and the exterior portion of the nozzle; and
a secondary gas passageway extending between the distal end of the nozzle cavity and the exterior portion of the nozzle,
wherein the secondary gas passageway is smaller than the primary gas passageway and the gas passageways function to smooth the flow of gas through the gas pressure regulator.

2. The gas pressure regulator according to claim 1 wherein the nozzle cavity defines a longitudinal axis, at least one of the primary gas passageway and said secondary gas passageway extending generally perpendicular to said longitudinal axis of said nozzle cavity.

3. The gas pressure regulator according to claim 1 wherein the nozzle cavity defines a longitudinal axis, at least one of the primary gas passageway and said secondary gas passageway extending generally parallel to said longitudinal axis of said nozzle cavity.

4. The gas pressure regulator according to claim 1 wherein the nozzle cavity defines a longitudinal axis, at least one of the primary gas passageway and said secondary gas passageway extending at an angle less than about 90 degree relative to said longitudinal axis of said nozzle cavity.

5. A gas pressure regulator comprising:
a regulator body;
a nozzle disposed within the regulator body, the nozzle comprising:
an interior portion and an exterior portion;
a nozzle cavity disposed within the interior portion, the nozzle cavity defining a proximal end and a distal end;
a primary gas passageway extending between the proximal end of the nozzle cavity and the exterior portion of the nozzle;
a secondary gas passageway extending between the distal end of the nozzle cavity and the exterior portion of the nozzle; and
a flow channel groove disposed within the nozzle cavity adjacent the primary gas passageway,
wherein the secondary gas passageway is smaller than the primary gas passageway, and the primary and secondary gas passageways and the flow channel groove cooperate to smooth the flow of gas through the gas pressure regulator.

6. A gas pressure regulator comprising a regulator body, the regulator body comprising:
a proximal end portion and a distal end portion;
a cavity disposed within the distal end portion, the cavity defining a plurality of angled walls,
wherein the angled walls diffuse and distribute a flow of gas within the gas pressure regulator.

7. A gas pressure regulator comprising a regulator body, the regulator body comprising:
a means for smoothing the flow of a gas between an interior portion of the regulator body and an outlet port of the regulator body.

8. A nozzle for use in a gas pressure regulator comprising:
an interior portion and an exterior portion;
a nozzle cavity disposed within the interior portion, the nozzle cavity defining a proximal end and a distal end;
a primary gas passageway extending between the proximal end of the nozzle cavity and the exterior portion of the nozzle; and
a secondary gas passageway extending between the distal end of the nozzle cavity and the exterior portion of the nozzle,
wherein the secondary gas passageway is smaller than the primary gas passageway and the gas passageways function to smooth the flow of gas through the gas pressure regulator.

9. A nozzle for use in a gas pressure regulator comprising:
an interior portion and an exterior portion;
a nozzle cavity disposed within the interior portion, the nozzle cavity defining a proximal end and a distal end;
a primary gas passageway extending between the proximal end of the nozzle cavity and the exterior portion of the nozzle;
a secondary gas passageway extending between the distal end of the nozzle cavity and the exterior portion of the nozzle; and
a flow channel groove disposed within the nozzle cavity adjacent the primary gas passageway,
wherein the secondary gas passageway is smaller than the primary gas passageway, and the primary and secondary gas passageways and the flow channel groove function to smooth the flow of gas through the gas pressure regulator.

10. A nozzle for use in a gas pressure regulator comprising:
an interior portion;
a nozzle cavity disposed within the interior portion; and
a flow channel groove disposed within the nozzle cavity,
wherein the flow channel groove functions to smooth the flow of gas through the gas pressure regulator.

11. A nozzle for use in a gas pressure regulator comprising:
an interior portion and an exterior portion;
a nozzle cavity disposed within the interior portion, the nozzle cavity defining a proximal end and a distal end;
a primary gas passageway extending between the proximal end of the nozzle cavity and the exterior portion of the nozzle;
a secondary gas passageway extending between the distal end of the nozzle cavity and the exterior portion of the nozzle; and
a flow channel groove disposed within the nozzle cavity adjacent the primary gas passageway,
wherein the secondary gas passageway is smaller than the primary gas passageway, and the gas passageways and the flow channel groove function to smooth the flow of gas through the gas pressure regulator.

12. A regulator body for use in a gas pressure regulator comprising:
a proximal end portion and a distal end portion;
a cavity disposed within the distal end portion, the cavity defining a plurality of angled walls,
wherein the angled walls diffuse and distribute a flow of gas within the gas pressure regulator.

13. A regulator body for use in a gas pressure regulator comprising:
a means for smoothing the flow of a gas between an interior portion of the regulator body and an outlet port of the regulator body.

14. A regulator body for use in a gas pressure regulator comprising:
a proximal end portion and a distal end portion;
a cavity disposed within the distal end portion, the cavity defining a plurality of angled walls;
an interior portion and an exterior portion;
an outlet port extending between the interior portion and the exterior portion; and
a plurality of gas passageways extending between the interior portion and the outlet port,
wherein the angled walls diffuse and distribute a flow of gas within the gas pressure regulator and the plurality of gas passageways smooth a flow of gas through the gas pressure regulator.

15. A gas pressure regulator comprising:
a regulator body comprising:
a proximal end portion and a distal end portion;
a cavity disposed within the distal end portion, the cavity defining a plurality of angled walls;
an interior portion and an exterior portion;
an outlet port extending between the interior portion and the exterior portion; and
a plurality of gas passageways extending between the interior portion and the outlet port; and
a nozzle disposed within the regulator body, the nozzle comprising: an interior portion and an exterior portion;
a nozzle cavity disposed within the interior portion, the nozzle cavity defining a proximal end and a distal end;
a primary gas passageway extending between the proximal end of the nozzle cavity and the exterior portion of the nozzle;
a secondary gas passageway extending between the distal end of the nozzle cavity and the exterior portion of the nozzle; and
a flow channel groove disposed within the nozzle cavity adjacent the primary gas passageway,
wherein the angled walls of the regulator body diffuse and distribute a flow of gas within the gas pressure regulator, and the plurality of gas passageways smooth a flow of gas through the gas pressure regulator, and
wherein the secondary gas passageway is smaller than the primary gas passageway and the gas passageways and the flow channel groove function to smooth the flow of gas through the gas pressure regulator.

16. A method of operating a gas pressure regulator, the method comprising the steps of:
directing a flow of gas through a nozzle cavity;
directing at least a portion of the gas through a primary gas passageway in communication with the nozzle cavity; and
directing another portion of the gas through a secondary gas passageway in communication with the nozzle cavity,
wherein the gas flow through the primary and secondary gas passageways smooth the flow of gas through the gas pressure regulator.

17. A method of operating a gas pressure regulator, the method comprising the steps of:
directing a flow of gas through a nozzle cavity;
directing at least a portion of the gas through a primary gas passageway in communication with the nozzle cavity;
directing another portion of the gas through a secondary gas passageway in communication with the nozzle cavity; and
directing another portion of the gas into a flow channel groove in communication with the nozzle cavity,
wherein the gas flow through the primary and secondary gas passageways and into the flow channel groove smooth the flow of gas through the gas pressure regulator.

18. A method of operating a gas pressure regulator, the method comprising the steps of:
directing a flow of gas through a regulator body defining cavity; and
distributing the flow of gas within the cavity through a plurality of angled walls.

19. A method of operating a gas pressure regulator, the method comprising the steps of:
directing a flow of gas through a regulator body defining cavity;
distributing the flow of gas within the cavity through a plurality of angled walls; and
directing the flow of gas through a plurality of gas passageways in communication with an outlet port.

20. A method of operating a gas pressure regulator, the method comprising the steps of:
directing a flow of gas through a nozzle cavity;
directing at least a portion of the gas through a primary gas passageway in communication with the nozzle cavity;
directing another portion of the gas through a secondary gas passageway in communication with the nozzle cavity;
directing another portion of the gas into a flow channel groove in communication with the nozzle cavity;
directing the flow of gas into a regulator body cavity;
distributing the flow of gas within the cavity through a plurality of angled walls; and
directing the flow of gas through a plurality of gas passageways in communication with an outlet port,
wherein the gas flow through the primary and secondary gas passageways, into the flow channel groove, and through the plurality of gas passageways in communication with the outlet port, smooth the flow of gas through the gas pressure regulator.

21. A gas pressure regulator comprising:
a means for smoothing the flow of gas through a nozzle disposed within the gas pressure regulator; and
a means for smoothing the flow of a gas through a regulator body disposed within the gas pressure regulator.
